(19) United States
(12) Patent Application Publication
(10) Pub. No.: US 2008/0119137 A1
(43) Pub. Date: May 22, 2008

(54) Multi-band multi-mode terminal having short-range wireless communication module

(76) Inventor: Young-Jin Lee, Seongnam-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/906,718

(22) Filed: Oct. 3, 2007

Related U.S. Application Data
(63) Continuation of application No. PCT/KR2006/003667, filed on Sep. 14, 2006.

(30) Foreign Application Priority Data
Dec. 9, 2005 (KR) 10-2005-0120876

(51) Int. Cl. H04B 7/00

(52) U.S. Cl. 455/41.2

(57) ABSTRACT

A multi-band multi-mode (MBMM) terminal having a short-range wireless communication module and communication method thereof are disclosed. In one embodiment, the method comprises i) receiving data, at a first modem of the MBMM terminal, from a first communication network, wherein the MBMM terminal comprises a short-range wireless communication module, ii) converting the received data into a data having a pre-configured format and iii) outputting the converted data from a second modem of the MBMM terminal through the short-range wireless communication module. At least one embodiment of the present invention allows Bluetooth functionality in a plurality of communication services, such as of WCDMA type and CDMA type, etc., with one Bluetooth module.

### RELATED APPLICATIONS

This application is a continuation application, and claims the benefit under 35 U.S.C. §§ 120 and 365 of PCT Application No. PCT/KR2006/003667, filed on Sep. 14, 2006, which is hereby incorporated by reference.

### BACKGROUND OF THE INVENTION

1. Field of the Invention

The present invention relates to a multi-band multi-mode (MBMM) terminal, and in particular, to an MBMM terminal having a short-range wireless communication module and communication method thereof.

2. Description of the Related Technology

In general, a mobile communication terminal is a portable device which, even while in motion, allows voice calls with a receiver in a remote location. Although the mobile communication terminal allowed only voice communication in its early stages, it is evolving towards data communication types, for using letters and symbols, and multimedia communication types, which include video signals.

Since voice and letter communication types entail relatively small data capacities, they were suited for code division multiple access (hereafter referred to as “CDMA”) type mobile communication systems. However, the latest multimedia communication types in which video signals are included involve large amounts of data, to necessitate a mobile communication system that allows fast data transmission. One such system is the third generation partnership project (3GPP) mobile communication system, an example of which is the wideband code division multiple access (hereafter referred to as “WCDMA”) type mobile communication system.

### SUMMARY OF CERTAIN INVENTIVE ASPECTS

One aspect of the invention provides an MBMM terminal having a short-range wireless communication module and communication method thereof which allow Bluetooth functionality in WCDMA type and CDMA type services.

Another aspect of the invention provides an MBMM terminal having a short-range wireless communication module and communication method therefor with which a phone conversation may be performed continuously using a Bluetooth device, even in the event of a hand over between a WCDMA network and a CDMA network.

Another aspect of the present invention provides a communication method and a MBMM (multi-band multi-mode) terminal-readable recording medium storing a program to cause the MBMM terminal to execute the method for an MBMM (multi-band multi-mode) terminal having a short-range wireless communication module and comprising a first modem connecting to a first communication network and a second modem connecting to a second communication network, where the method comprises converting incoming data received by the first modem from the first communication network into converted incoming data of a pre-configured format, and outputting the converted incoming data from the second modem through a short-range wireless communication module joined to the second modem.

Here, the converted incoming data may be generated by PCM (pulse-code modulation).

Also, the first modem may transmit the converted incoming data to the second modem by IPC (inter-process communication).

In addition, the method may further comprise receiving by the second modem of outgoing data of a pre-configured format from the short-range wireless communication module, transmitting by the second modem of the outgoing data to the first modem, converting by the first modem of the outgoing data into converted outgoing data corresponding to the first communication network, and transmitting by the first modem of the converted outgoing data to the first communication network.

Also, the method may be preceded by searching by the second modem of a short-range communication device communicating with the short-range wireless communication module, and transmitting by the second modem of information corresponding to the short-range communication device to the first modem.

Another aspect of the invention provides an MBMM (multi-band multi-mode) terminal having a short-range wireless communication module comprising a first modem connecting to a first communication network, a second modem connecting to a second communication network and joined with the first modem by IPC (inter-process communication), and a short-range wireless communication module joined to the second modem, wherein the first modem transmits incoming data received from the first communication network via the second modem to the short-range wireless communication module.

Also, an MBMM terminal having a short-range wireless communication module is provided, comprising a first modem connecting to a first communication network and a second modem connecting to a second communication network, wherein the first modem transmits incoming data received from the first communication network to a short-range wireless communication module joined with the second modem.

Here, the first modem may transmit outgoing data transmitted via the second modem from the short-range wireless communication module to the first communication network.

The first modem may also convert the incoming data into converted incoming data, of a pre-configured format that can be processed by the short-range wireless communication module, and may transmit the converted incoming data to the second modem. Further, the converted incoming data may be generated by PCM (pulse-code modulation).

Also, the second modem may search for a short-range communication device communicating with the short-range wireless communication module and may transmit information corresponding to the short-range communication device to the first modem.

Another aspect of the invention provides a method of processing data in an multi-band multi-mode (MBMM) communication terminal, the method comprising: i) receiving data, at a first modem of the MBMM terminal, from a first communication network, wherein the MBMM terminal comprises a short-range wireless communication module, ii) converting the received data into a data having a pre-configured format and iii) outputting the converted data from a second modem of the MBMM terminal through the short-range wireless communication module.

Another aspect of the invention provides a multi-band multi-mode (MBMM) communication terminal, comprising: i) a first modem configured to communicate data with a first communication network, ii) a second modem configured to communicate data with a second communication network and the first modem and iii) a short-range wireless communication module configured to communicate data with the second modem, wherein the first modem is further configured to transmit incoming data received from the first communication network via the second modem to the short-range wireless communication module.

Still another aspect of the invention provides a multi-band multi-mode (MBMM) communication terminal, comprising: i) means for receiving data, at a first modem of the MBMM terminal, from a first communication network, wherein the MBMM terminal comprises a short-range wireless communication module, ii) means for converting the received data into a data having a pre-configured format and iii) means for outputting the converted data from a second modem of the MBMM terminal through the short-range wireless communication module.

### BRIEF DESCRIPTION OF THE DRAWINGS

Embodiments of the present invention will be described in conjunction with the accompanying drawings.

FIG. 1 is a schematic diagram of a system for providing a communication service using an MBMM terminal having a Bluetooth module, according to one embodiment of the invention.

FIG. 2 is a diagram of an MBMM terminal according to one embodiment of the invention.

FIG. 3 illustrates a process by which an MBMM terminal having a Bluetooth module recognizes a Bluetooth device according to one embodiment of the invention.

FIG. 4 illustrates a communication process of an MBMM terminal having a Bluetooth module according to one embodiment of the invention.

### DESCRIPTION OF CERTAIN INVENTIVE EMBODIMENTS

Generally, a mobile communication terminal can be classified into various types according to the type of connection to a mobile communication network, such as i) a CDMA terminal, which can be connected to a CDMA type mobile communication system for voice and data communication, a WCDMA terminal, which can be connected to ii) a WCDMA type mobile communication system for multimedia communication, and iii) an MBMM terminal, which is able to selectively connect to either the CDMA type or the WCDMA type. An MBMM terminal providing two services of WCDMA type and CDMA type is merely an example, and it is obvious that other communication services may be provided, such as of a GSM type, etc., and that more than two services may be provided. Hereinafter, the description will use as an example the case where two services are provided, of the WCDMA type and CDMA type.

Also, there is a recent trend of terminals being equipped with short-range wireless communication modules, such as Bluetooth modules, which allow short-range wireless communication. Short-range wireless communication refers to communication that allows the wireless exchange of data between devices within a short range using radio waves. Although short-range communication was in most cases implemented as wired communication, in which the devices are connected with wires, it is being replaced by wireless communication, due to advantages in mobility and installation.

Short-range wireless communication technologies include wireless LAN (WLAN), Bluetooth, infrared data association (IrDA), ZigBee, and ultra-wideband (UWB), etc. Among these technologies, Bluetooth is a technological standard for wirelessly connecting a portable terminal (e.g., portable phones, laptops, etc.) to other peripheral devices within a short range (about 10 to about 100 m) with small equipment, low cost, and low power consumption. That is, Bluetooth is a short-range wireless communication standard that connects a computer with peripherals, and a portable terminal with household appliances, etc., that are located within a short range, in a wireless network to allow bi-directional real-time communication without any intricate wiring.

Devices that enable such Bluetooth communication (hereafter referred to as “Bluetooth modules”), are already being used in interphones in an office environment, in wireless phones in a home environment, and in 3-in-1 telephone systems in an outdoor environment, and terminals having Bluetooth modules can exchange data instantly during a meeting without any exterior connection devices. Further, data may be exchanged between various terminals such as a PDA, PC, and cell phone, etc., without any wire connections, and since computer peripherals such as a mouse, keyboard, and printer, etc., may be connected wirelessly, the need for intricate wiring around the computer is eliminated to allow easier movement.

Lately, portable terminals and headsets, etc., having such Bluetooth modules have appeared in the market. That is, portable terminals are commercially available that use Bluetooth modules to transmit various data to peripheral devices having Bluetooth modules (hereafter referred to as “Bluetooth devices”), such as wireless headsets and wireless speakers, etc. Functions of the portable terminal having a Bluetooth module, such as having phone conversations or playing music files, etc., can be performed using Bluetooth devices, and the user can control the portable terminal located within a short range without any wire connections.

A typical CDMA terminal or a WCDMA terminal required only one Bluetooth module, as it was equipped with only one modem. However, the MBMM terminal may include two or more modems (e.g., WCDMA modem and CDMA modem), so that the providing of Bluetooth modules to correspond with each communication type becomes an important issue. Thus, a Bluetooth module can be equipped on each modem or on just one modem, or a structure may be applied which uses one Bluetooth module and a multiplexer (MUX) to perform switching between either modem.

Using an MBMM terminal with a Bluetooth module equipped on each modem is inefficient, and moreover causes the problem of increases in the overall cost and size of the terminal, due to the equipment of multiple Bluetooth modules. In addition, when a Bluetooth module is equipped on each modem, problems may arise when different versions of Bluetooth specifications are used, and even when the same version is used, the same updates may need to be performed for both modules when one version is updated, not to mention other problems that may occur due to the large changes in the architecture of the software. When a Bluetooth module is equipped on just one modem, not only is the Bluetooth function unavailable in the other modem, a phone conversation over a Bluetooth device will be discontinued when the phone conversation performed using the modem with the equipped Bluetooth module is handed over to the other modem. Lastly, using one Bluetooth module and a multiplexer allows only hardware switching, and not software switching such as codec conversion for voice data, etc. If the voice data codec conversion is not performed, a phone conversation over a Bluetooth device will be discontinued when the phone conversation performed by connecting to a WCDMA network using the MBMM terminal having a Bluetooth module or a Bluetooth device (e.g., a wireless headset) is handed over to a CDMA network. This is because CDMA and WCDMA use different voice codecs, such as pulse-code modulation (PCM) and enhanced variable rate codec (EVRC), etc.

Reference will now be made in detail to embodiments of the present invention, examples of which are illustrated in the accompanying drawings, wherein like reference numerals refer to the like elements throughout, and redundant explanations are omitted.

It is appreciated that embodiments of the invention described here are merely exemplary. In the descriptions that follow, Bluetooth is used as an example of short-range wireless communication, although it is apparent that other short-range wireless communication technologies are equally applicable, such as Infrared Data Association (IrDA), ZigBee, and Ultra-wideband (UWB) technologies. Also, a wireless headset is used as an example of a Bluetooth device capable of Bluetooth communication with the MBMM terminal, although it is apparent that other devices having Bluetooth modules are equally applicable, such as wireless speakers, etc.

In addition, although the example is used of a case where the MBMM (multi-band multi-mode) terminal provides WCDMA type and CDMA type services, it is apparent that the MBMM terminal may provide communication services corresponding to three or more communication networks.

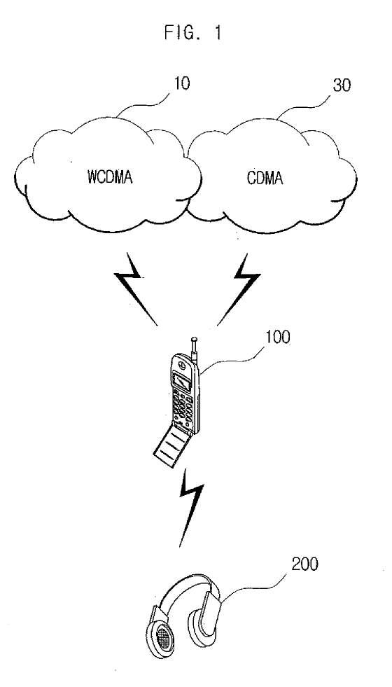

FIG. 1 is a schematic diagram of a system for providing a communication service using an MBMM terminal having a Bluetooth module, according to one embodiment of the invention.

Referring to FIG. 1, the system comprises a WCDMA network 10, a CDMA network 30, an MBMM terminal 100, and a wireless headset 200.

The WCDMA network 100 and CDMA network 30 include communication stations and operators, and are communication networks that provide wireless communication services to mobile terminals including MBMM terminals 100. Since the WCDMA network 10 and CDMA network 30 are communication networks that are currently in use, detailed explanations will be omitted.

The MBMM terminal 100 is a mobile terminal which is able to use the WCDMA network 10 and CDMA network 30 selectively, and the MBMM terminal 100, in particular, may have a Bluetooth module for wireless communication with the wireless headset 200. Thus, the MBMM terminal 100 can send/receive not only voice data, related to voice conversations and/or video conversations, etc., but also multimedia data to/from other mobile terminals, etc., to transmit data received from a communication network to the wireless headset 200 and transmit data received from the wireless headset 200 to a communication network using the Bluetooth function. Hereinafter, voice data will be used as an example of data transmitted to the wireless headset 200, although it will be more readily appreciated from the following descriptions that multimedia data such as video data, etc., is equally applicable.

The wireless headset 200 is one of various Bluetooth devices that include Bluetooth modules to be capable of short-range wireless communication with the MBMM terminal 100, and is a device for performing voice calls through the MBMM terminal 100.

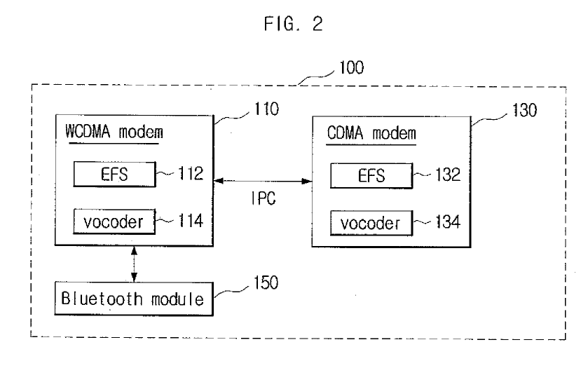

FIG. 2 is a diagram of an MBMM terminal according to one embodiment of the invention.

Referring to FIG. 2, an MBMM terminal 100 comprises a WCDMA modem 110, a CDMA modem 130, and a Bluetooth module 150.

The WCDMA modem 110 connects to a WCDMA network 10 to send/receive data to/from other mobile terminals, personal computers, and content-provider servers (e.g., portal websites such as Naver [www.naver.com]), etc. Likewise, the CDMA modem 130 connects to a CDMA network 30 to send/receive data.

In particular, the WCDMA modem 110 is joined with the Bluetooth module 150, and is capable of wireless communication with Bluetooth devices such as the wireless headset 200. Hereinafter, the WCDMA modem 110, which is joined with the Bluetooth module 150, will be referred to as the master modem, and the CDMA modem 130 will be referred to as the slave modem.

The WCDMA modem 110, which is the master modem, uses the Bluetooth module 150 to search for devices such as the wireless headset 200 that are capable of short-range wireless communication. If the wireless headset 200 is found, the WCDMA modem 110 stores information (e.g., device type, frequency used, etc.) related to the found wireless headset 200 in an EFS (embedded file system) 112. Of course, the EFS 112 is only one example of a storage means, and it is apparent that other storage means are equally applicable.

Further, the WCDMA modem 110 may transmit the information related to the found wireless headset 200 to the CDMA modem 130, and the CDMA modem 130 may store this in an equipped storage means (e.g., EFS 132, as shown in FIG. 2). The CDMA modem 130 may also recognize a Bluetooth communication operation so that a Bluetooth communication operation may be performed continuously, for example, when a data communication operation performed over a WCDMA network 10 is handed over to a CDMA network 30. Of course, the WCDMA modem 110 may also provide the corresponding information to the CDMA modem 130 only in the event of a hand-over. Here, the WCDMA modem 110 and CDMA modem 130 are joined by IPC (inter-process communication) to enable data transmission between the two modems.

The WCDMA modem 110 and CDMA modem 130 convert the data (hereafter referred to as “incoming data”) received from their respective communication networks into data of a pre-configured format at their respective vocoders 114, 134 and provide the data to the Bluetooth module 150. Data generated by PCM (pulse-code modulation) (hereafter referred to as “PCM data”) may be used for the data of a pre-configured format. That is, the WCDMA modem 110 converts incoming data, received from the WCDMA network 10, of a particular format (e.g., adaptive multi-rate: AMR) used by the WCDMA network 10 into a PCM data format, and provides the data to the Bluetooth module 150. Also, the CDMA modem 130 converts incoming data, received from the CDMA network 30, of a particular format (e.g., enhanced variable rate codec: EVRC) used by the CDMA network 30 into a PCM data format, and transmits the data via the WCDMA modem 110 to the Bluetooth module 150. A similar process is used for the reverse case, where the WCDMA modem 110 and CDMA modem 130 convert the data (hereafter referred to as “outgoing data”) of a PCM data format received from the Bluetooth module 150 into a data format corresponding to their respective communication networks and transmit the data to the corresponding communication networks.

The Bluetooth module 150 is joined with the WCDMA modem 110 and performs wireless communication operations with the wireless headset 200. The Bluetooth module 150 can transmit outgoing data received from the wireless headset 200 via the WCDMA modem 110 to the WCDMA network 10. Also, when the CDMA modem 130, which is the slave modem, is activated and connected to the CDMA network 30, the Bluetooth module 150 receives outgoing data transmitted from the wireless headset 200 via the WCDMA modem 110 and transmits the data to the CDMA network 30. A similar process is used for the reverse case, where the Bluetooth module 150 receives incoming data, received from a communication network, from the WCDMA modem 110 or via the WCDMA modem 110 from the CDMA modem 130 and transmits the data to the wireless headset 200.

Although the Bluetooth module 150 is illustrated as a hardware form separated from the WCDMA modem 110, it may also be built into the WCDMA modem 110. That is, a Bluetooth baseband may be included in the WCDMA modem 110, such as in WCDMA modem chips currently available, with only the RF end for wireless communication with the wireless headset 200 positioned exteriorly to the WCDMA modem 110. This is a matter only of implementing the WCDMA modem 110 and Bluetooth module 150, and it will be appreciated by those skilled in the art that all methods are equally applicable that include a means of communication with a WCDMA network 10 and a means of performing Bluetooth functionality.

Although the foregoing describes the WCDMA modem 110 as the master modem joining with the Bluetooth module 150, it is apparent that the CDMA modem 130 can be the master modem joining with the Bluetooth module 150.

Hereinafter, the process will be described by which an MBMM terminal 100 according to one embodiment of the invention uses the Bluetooth module 150 to wirelessly communicate with the wireless headset 200, and enable a phone conversation via a CDMA network 30.

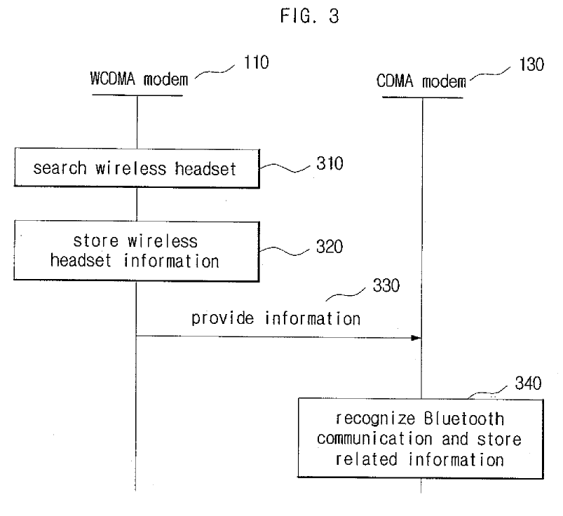

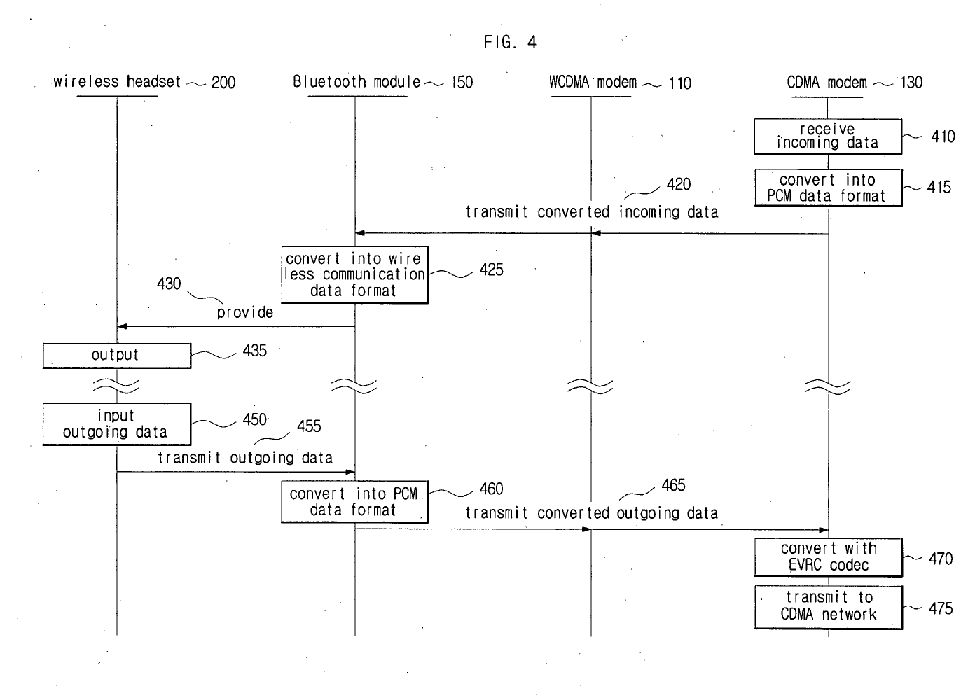

FIG. 3 illustrates a process by which an MBMM terminal having a Bluetooth module recognizes a Bluetooth device according to one embodiment of the invention, and FIG. 4 illustrates a communication process of an MBMM terminal having a Bluetooth module according to one embodiment of the invention.

Referring to FIG. 3, as a user inputs a Bluetooth communication command to the MBMM terminal 100 for communication using the wireless headset 200, the WCDMA modem 110 searches for nearby Bluetooth devices and recognizes the wireless headset 200 in step 310.

Then, in steps 320 and 330, the WCDMA modem 110 stores information related to the found wireless headset 200, and provides the information to the CDMA modem 130 joined by IPC. In step 340, the CDMA modem 130 recognizes that a Bluetooth communication is performed, and stores the received information related to the wireless headset 200.

If a phone conversation is currently being performed over the WCDMA network 10, the WCDMA modem 110 wirelessly communicates with the wireless headset 200 through the Bluetooth module 150, and if a phone conversation is being performed over the CDMA network 30, the CDMA modem 130 wirelessly communicates with the wireless headset 200 through the WCDMA modem 110 and the Bluetooth module 150.

Here, steps 330 and 340 may be omitted if a phone conversation is currently being performed over the WCDMA network 10, and may be performed only in the event of a hand-over to the CDMA network 30. In other words, since it is not necessary to use the CDMA modem 130 while a connection is made to the WCDMA network 10, the information related to the wireless headset 200 is not provided. However, later, when a hand-over occurs to the CDMA network 30, the related information may be provided which allows the CDMA modem 130 to recognize that a Bluetooth function is currently being performed through the wireless headset 200.

Hereinafter, the descriptions will assume the case where the MBMM terminal 100 connects to a CDMA network 30 for a voice communication with another mobile terminal.

Referring to FIG. 4, in steps 410 and 415, the CDMA modem 130 receives incoming data from the CDMA network 30, and converts the incoming data into a PCM data format when it recognizes that a Bluetooth communication is currently being performed. If a Bluetooth communication is not currently being performed, the CDMA modem 130 may convert the incoming data with a corresponding codec so that it may be outputted through a display device and/or speakers, etc., of the MBMM terminal 100.

In step 420, when the CDMA modem 130 transmits the converted incoming data to the WCDMA modem 110, the WCDMA modem 110 transmits the converted incoming data to the joined Bluetooth module 150.

In steps 425 to 435, the Bluetooth module 150 converts the converted incoming data of a PCM data format into a pre-configured data format (e.g., an analog signal having a frequency of about 2.4 GHz) that can be processed by the wireless headset 200 and transmits the data to the wireless headset 200, and on receiving the data, the wireless headset 200 provides an output through speakers, etc.

Later, in the reverse case, where the wireless headset 200 transmits data to the CDMA network 30, the wireless headset 200 transmits outgoing data, such as voice signals, etc., inputted by the user, to the Bluetooth module 150 in steps 450 and 455.

In steps 460 and 465, when the Bluetooth module 150 converts the outgoing data received from the wireless headset 200 into a PCM data format and transmits the data to the WCDMA modem 110, the WCDMA modem 110 transmits the converted outgoing data to the CDMA modem 130.

In steps 470 and 475, the CDMA modem 130 converts the received converted outgoing data of a PCM data format with EVRC, which is a voice data codec used in the CDMA network 30, and transmits the data to the CDMA network 30.

Thus, the CDMA modem 130 enables Bluetooth functionality using the Bluetooth module 150 joined to the WCDMA modem 110.

Embodiments of the method of the invention, such as set forth above, may be implemented as a software program and may be stored in a recorded medium (CD, RAM, ROM, floppy disk, hard disk, optical disk, etc.) readable by a computer.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

According to at least one embodiment of the present invention as described above, an MBMM terminal having a short-range wireless communication module and communication method thereof may be provided which allow Bluetooth functionality in a plurality of communication services, such as of WCDMA type and CDMA type, etc., with one Bluetooth module.

In addition, an MBMM terminal having a short-range wireless communication module and communication method thereof may be provided with which a phone conversation may be performed continuously using a Bluetooth device, even in the event of a hand over between different communication networks, such as a WCDMA network and a CDMA network.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of processing data in an multi-band multi-mode (MBMM) communication terminal, the method comprising:
receiving data, at a first modem of the MBMM terminal, from a first communication network, wherein the MBMM terminal comprises a short-range wireless communication module; converting the received data into a data having a pre-configured format; and outputting the converted data from a second modem of the MBMM terminal through the short-range wireless communication module.

2. The method of claim 1, wherein the pre-configured format comprises a pulse-code modulation (PCM) format.

3. The method of claim 1, wherein the converting is performed by the first modem.

4. The method of claim 1, further comprising:
transmitting, at the first modem, the converted data to the second modem via an inter-process communication (IPC) protocol.

5. The method of claim 1, wherein the short-range wireless communication module is electrically connected to the second modem.

6. The method of claim 1, further comprising:
receiving, at the second modem, data having a pre-configured format from the short-range wireless communication module;
transmitting, at the second modem, the received data to the first modem;
converting, at the first modem, the received data into data corresponding to the first communication network; and
transmitting, at the first modem, the converted data to the first communication network.

7. The method of claim 1, further comprising:
before the receiving, searching, at the second modem, a short-range communication device communicating with the short-range wireless communication module; and
transmitting, at the second modem, information corresponding to the short-range communication device to the first modem.

8. The method of claim 1, wherein the first modem comprises a wideband code division multiple access (WCDMA) modem and the second modem comprises a code division multiple access (CDMA) modem.

9. The method of claim 1, wherein the short-range wireless communication module is one of the following: a wireless LAN (WLAN) module, a Bluetooth module, an infrared data association (IrDA) module, a ZigBee module, and an ultra-wideband (UWB) module.

10. A multi-band multi-mode (MBMM) communication terminal, comprising:
a first modem configured to communicate data with a first communication network;
a second modem configured to communicate data with a second communication network and the first modem; and
a short-range wireless communication module configured to communicate data with the second modem,
wherein the first modem is further configured to transmit incoming data
received from the first communication network via the second modem to the short-range wireless communication module.

11. The MBMM terminal of claim 10, wherein the first modem is configured to communicate data with the second modem via an inter-process communication (IPC) protocol.

12. The MBMM terminal of claim 10, wherein the first modem is further configured to i) receive data from the short-range wireless communication module via the second modem and ii) transmit the received data to the first communication network.

13. The MBMM terminal of claim 10, wherein the first modem is further configured to i) convert the incoming data into a data having a pre-configured format that can be processed by the short-range wireless communication module, and ii) transmit the converted incoming data to the second modem.

14. The MBMM terminal of claim 13, wherein the first modem is further configured to perform pulse-code modulation (PCM) so as to generate the converted data.

15. The MBMM terminal of claim 10, wherein the second modem is further configured to i) search for a short-range communication device communicating with the short-range wireless communication module and ii) transmit information corresponding to the short-range communication device to the first modem.

16. The MBMM terminal of claim 10, wherein the first modem comprises a wideband code division multiple access (WCDMA) modem and the second modem comprises a code division multiple access (CDMA) modem.

17. The MBMM terminal of claim 10, wherein the short-range wireless communication module is one of the following: a wireless LAN (WLAN) module, a Bluetooth module, an infrared data association (IrDA) module, a ZigBee module, and an ultra-wideband (UWB) module.

18. The MBMM terminal of claim 17, wherein the short-range wireless communication module is a Bluetooth module.

19. The MBMM terminal of claim 18, wherein the short-range wireless communication device is a wireless headset or a wireless speaker.

20. A multi-band multi-mode (MBMM) communication terminal, comprising:
means for receiving data, at a first modem of the MBMM terminal, from a first communication network, wherein the MBMM terminal comprises a short-range wireless communication module;
means for converting the received data into a data having a pre-configured format; and
means for outputting the converted data from a second modem of the MBMM terminal through the short-range wireless communication module.
